(19) United States
(12) Patent Application Publication
(10) Pub. No.: US 2020/0072457 A1
(43) Pub. Date: Mar. 5, 2020

(54) UNDERCABINET LIGHTING SYSTEM

(71) Applicant: ENHANCE PRODUCT DEVELOPMENT, INC., MINNEAPOLIS, MN (US)

(72) Inventors: Ty Joseph Caswell, Zimmerman, MN (US); Trevor John Lambert, Brooklyn Park, MN (US); Jonathan Northcutt Dunn, Maple Grove, MN (US)

(21) Appl. No.: 16/547,496

(22) Filed: Aug. 21, 2019

Related U.S. Application Data
(60) Provisional application No. 62/724,701, filed on Aug. 30, 2018.

(51) Int. Cl. F21V 33/00; F21V 23/02; F21V 21/108; F21V 21/26; F21V 21/22; F21V 23/06; F21S 9/03; F21V 23/04; H02J 7/02; H01R 33/06

(52) U.S. Cl. CPC F21V 33/0024; F21V 23/02; F21V 21/108; F21V 21/26; F21V 21/22; F21Y 2115/10; F21S 9/03; F21V 23/04; H02J 7/025; H02J 7/027; H01R 33/06; F21V 23/06

(57) ABSTRACT

An undercabinet lighting system is described that includes a light or lamp head assembly that is a flip-up LED halo ring with a telescoping stem. The base of the lighting system plugs into a wall outlet and in the preferred embodiment includes power outlets on the sides of the base housing. An advantage to the lighting system is that the stem and base housing are not directly against the wall which leaves room to place a cell phone in that space and off the counter while charging. In a related embodiment, the halo ring is configurable to provide light underneath and a wireless charging surface on the top surface.

### CLAIM OF PRIORITY

This application claims priority to and the benefit of US Provisional application entitled UNDERCABINET LIGHTING SYSTEM having Ser. No. 62/724,701 with a filing date of Aug. 30, 2018.

### FIELD AND BACKGROUND OF INVENTION

The following invention is in the field of undercabinet lighting. Currently there are a number of solutions for undercabinet lighting. One of these solutions attempts to install lights under the cabinet, but this solution fails to meet the needs of the market because this is a costly and permanent solution. Another solution attempts to use adhesive undercabinet lighting, but this solution is similarly unable to meet the needs of the market because some of these lights require batteries and the need to change them regularly or the adhesive ages and loses it adhesion properties. Still another solution seeks to use hardwired undercabinet lighting, but this solution also fails to meet market needs because these lights are affixed to the cabinet permanently and are difficult to install and permanently damage the cabinet.

### SUMMARY OF THE INVENTION

It would be advantageous to have an apparatus that provides light under a cabinet or anywhere that is convenient for the user. Furthermore, it would be advantageous to have an apparatus that not only provides light but offers one or more additional outlets when plugged into a wall outlet. Still further, it would be advantageous to have an apparatus that holds or cradles a cellphone (or electronic device in need of charging, such as small tablet PC or MP3 player) up and off the counter while charging. In a related embodiment, the cradling portion of the apparatus includes a wireless or an inductive charging pad for charging the electronic device. Therefore, there currently exists a need in the market for an apparatus that is a portable undercabinet lighting device or system.

The invention described herein advantageously fills the aforementioned deficiencies by providing an adjustable undercabinet lighting system, which provides lighting on counters when cooking or conducting other activities in the kitchen or other areas around the house or garage. The invention is universal for other lighting needs and in one example embodiment provides an additional one or two wall outlets on opposite sides of a base housing to avoid cluttering or interference. In another example embodiment, the lighting device or apparatus has a vertically extendable arm or stem that extends out of the main arm body of the lighting device.

Among other things, it is an advantage of the invention to provide an undercabinet lighting system that does not suffer from any of the problems or deficiencies associated with prior solutions. It is still further an advantage of the invention, in one embodiment but not necessarily limited, to use only AC power but batteries are an option if the lighting device is so configured. In one example embodiment, the lighting device has an LED halo of lights but in a related embodiment can include a light bar of LED lights, which can be directed down to where the lighting is needed.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 illustrates a perspective view of a collapsed lighting device according to the teachings herein.

FIG. 2 illustrates a rear view of the collapsed lighting of the device illustrating a light halo and an AC power prong in this embodiment.

FIG. 3 illustrates a bottom of a base housing of the lighting device and the AC prongs protruding therefrom.

FIG. 4 illustrates a side view of the lighting device when extended.

FIGS. 5 and 12 illustrate a perspective view of the extended lighting device with a light head assembly directing light rays down from the head assembly and a lighting and wireless charging assembly, respectively, with light rays emanating from a bottom surface and a wireless charging pad on a top surface.

FIG. 6 illustrates a front view of the collapsed lighting device illustrating an actuating member or button for turning on the light.

FIG. 7 illustrates a perspective view of the lighting device when opened in a first position and the arm cantilevering up and away from the base housing.

FIG. 8 illustrates a side of the lighting device in the first position.

FIG. 9 illustrates a right side view of the lighting device in a fully collapsed position or configuration.

FIG. 10 illustrates a left side view of the lighting device in a fully collapsed position or configuration.

FIG. 11 illustrates a top view of the lighting device illustrating a cantilevering hinge for the lighting head assembly when in a collapsed configuration.

FIG. 12 illustrates a perspective view of a lamp head assembly with an inductive or wireless charging apparatus.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The various embodiments of invention describe primarily, but are not limited to, an undercabinet lighting device and system that provides a user with additional lighting with a high level of convenience and a portable and easily stored form factor. In one example embodiment, an undercabinet lighting system is provided with a light head assembly that is a flip-up LED halo ring on a telescoping stem or arm. A base housing of the lighting system includes prongs (which can be retractable) to facilitate plugging the device into a wall outlet. On the opposite and lateral sides of the base housing are two additional power outlets. Since the light and arm or stem are not directly against the wall when the lighting device is plugged in, a user can perch or insert a cell phone in the available space between the wall and the arm of the lighting device and the cellphone remains off the counter while charging.

The lighting system or device or assemblies described herein is/are usable underneath upper cabinets, while the user is in the bathroom, while the user is doing crafts, painting fingernails, or doing other chores that may require additional and convenient lighting. The lighting device is configurable to provide additional features/options such as turning the light on/off when using it as a night light sensor or a motion sensor, and can be configured to be responsive to an on/off master control or a remote control when configured to have wireless communication capabilities (RF, IR or Bluetooth).

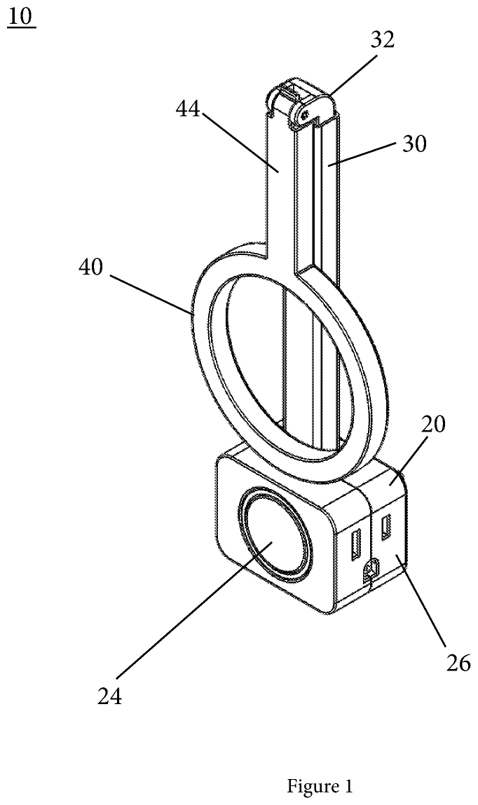

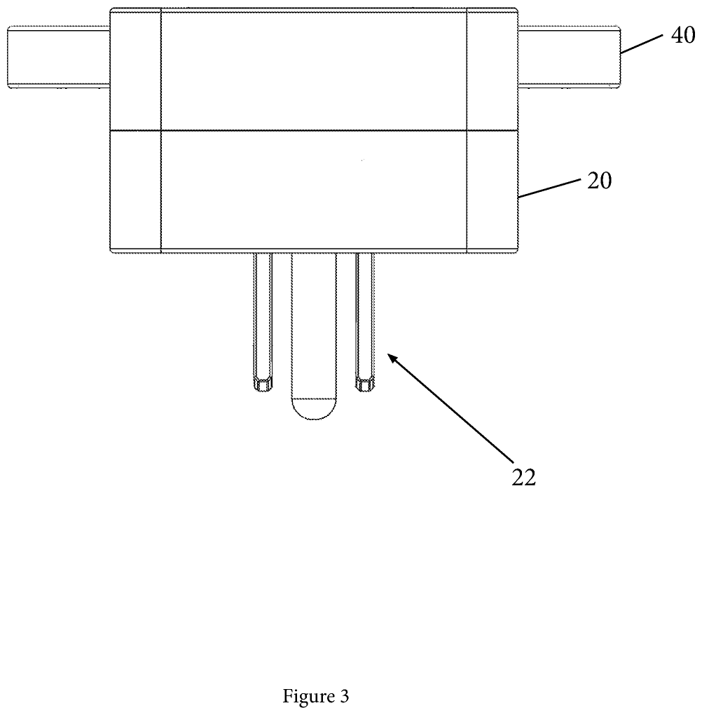

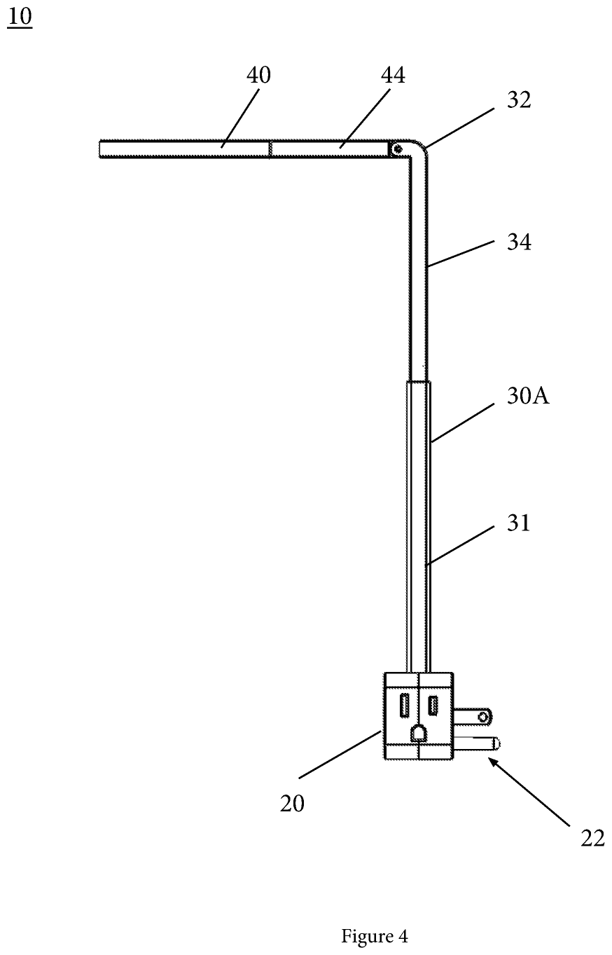

Referring to the Figures, FIGS. 1-5 illustrate a collapsed perspective view and other views of a lighting system 10 according to the teachings herein. In this example embodiment, lighting device or system 10 is primarily designed for, but not limited to, an undercabinet lighting device which includes a base housing 20 including therein an electrical circuit for providing a drive current to a light element and an actuating member or switch 24 for turning the current on and off. System 10 further includes an arm 30 extending from base housing 20 which includes a cantilevering portion or hinge 32 at a distal end of arm 30 spaced away from base housing 20. System 10 also includes a lamp head assembly 40 having a lateral portion 44 coupled to a distal end of cantilevering portion 32 of arm 30, with lamp head assembly 40 including a lighting element 42, such as an LED ring or halo. In a related embodiment, the lighting element is an LED light bar which provides a T-configuration with lateral portion 44. In this example embodiment, arm 30 need not be extendible.

In a preferred embodiment, lighting device 10 has an arm assembly 30A which has a body 31 which includes therein an extension or extendible member 34 that extends and retracts from body 31 depending on the user's needs. In this example embodiment, base housing 20 of lighting device 10 includes at least one a set of prongs 22 for AC power and in a related embodiment prongs 22 can also be configured to be electrically connected to a charging circuit so as to include a rechargeable battery in housing 20 as a backup power source to provide current to the lighting element. In another embodiment, housing 20 is configured to include batteries that may be disposable for ease of portability and storage of lighting system 10.

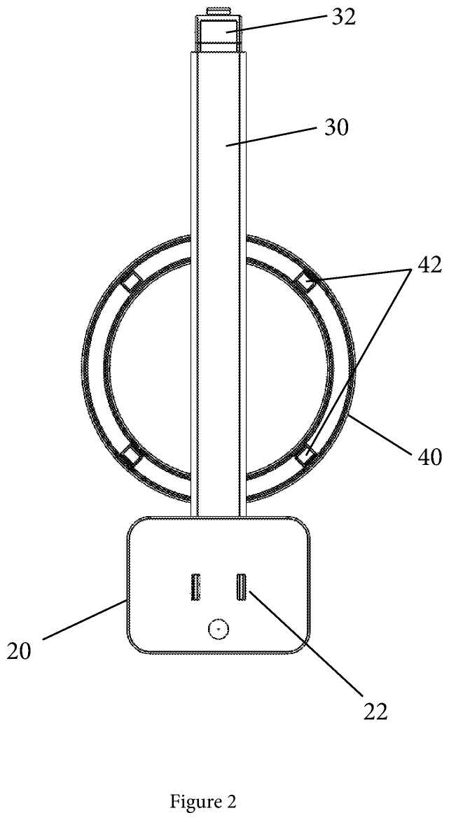

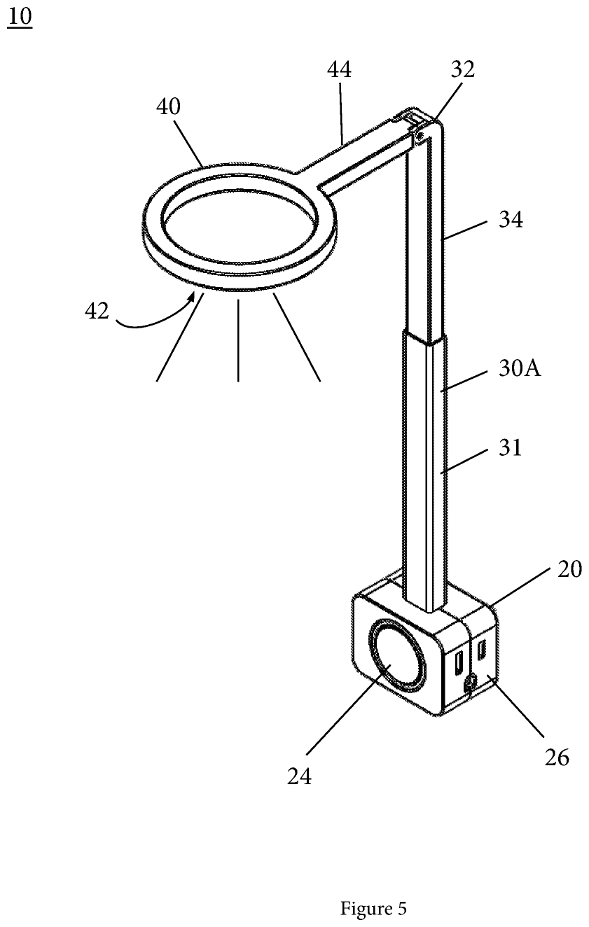

Referring briefly to FIGS. 2 and 5, lamp head assembly 40 includes at least one of a ring of LED lights (as shown) and a light bar populated with LED lights (not shown). Base housing of lighting device 10 includes at least one outlet thereon for providing AC power to an external device connected thereto. In a related embodiment, base housing 20 includes two power outlets and/or a USB or Firewire power charging outlet for charging or powering electronic devices. The electrical circuit included in housing 20 (not shown) is designed to convert electrical power from an AC power source to DC electrical power when the lighting device is connected to the AC power source. In yet another example embodiment, the electrical circuit in housing 20 is configured to magnetically charge electronic devices that are disposed near housing 20. Examples of power conversion circuits and DC circuits are shown in U.S. Pat. Nos. 8,820,965 and 8,872,435, which are herein incorporated by reference in their entireties. In another example embodiment, arm 30 of lighting device 10 is designed to include another hinge at the housing/arm point of contact to facilitate arm 30 cantilevering away from base housing 20 at a proximal end of arm 30. Lighting device 10 is also provides a compact configuration whereby lamp head assembly 40 collapses toward arm 30 and extension member 34 retracts into arm body 30A.

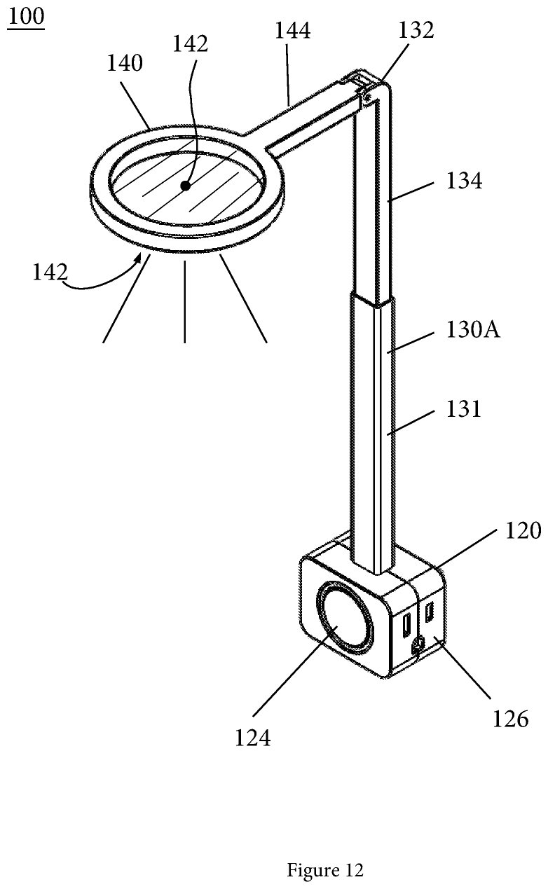

In another example embodiment and with reference to FIG. 12, there is illustrated a lamp head assembly with an inductive or wireless charging apparatus 100. In this example embodiment, a base housing 120 including therein an electrical circuit for providing a drive current to a light element and an actuating member or switch 124 for turning the current on and off. Assembly 100 further includes an arm 130A extending from base housing 120 which includes a cantilevering portion or hinge 132 at a distal end of arm 130A spaced away from base housing 120. Assembly 100 also includes a lamp head and wireless charging assembly 140 having a lateral portion 144 coupled to a distal end of cantilevering portion 132 of arm 130A, with lamp head assembly 140 including a lighting element 142 on a bottom surface or portion, such as an LED ring or halo, and a wireless or inductive charging pad 141 on a top surface or portion. Arm 130A of lighting and charging assembly 100 is designed to include another hinge at the housing/arm point of contact to facilitate arm 130A cantilevering away from base housing 120 at a proximal end of arm 130A. Assembly 100 also provides a compact configuration whereby lamp head assembly 140 collapses toward arm 130A and extension member 134 retracts into arm body 131. In this example embodiment, the actuating switch can have up to four states to control the light and charging pad as well as the on/off state.

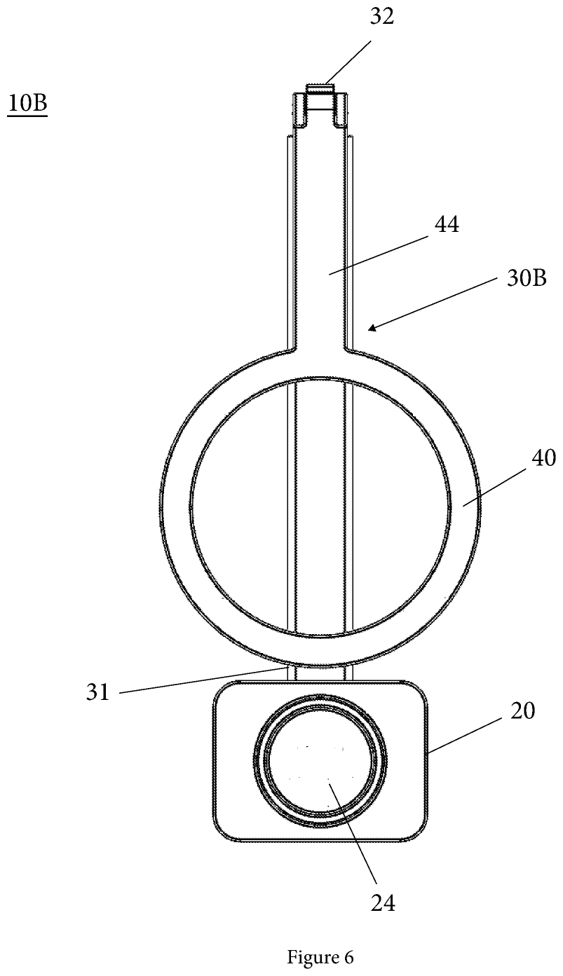

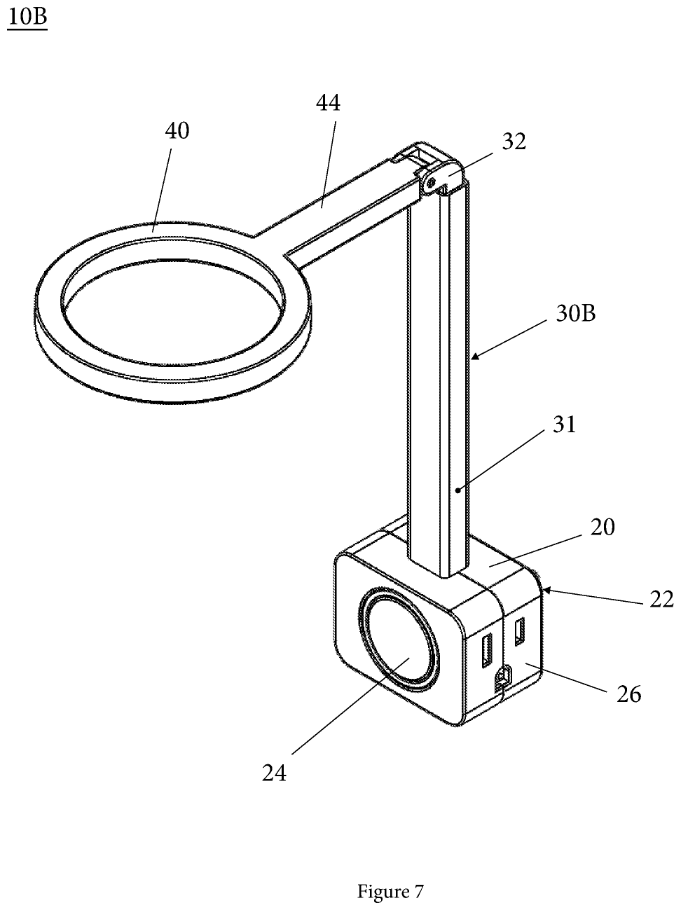

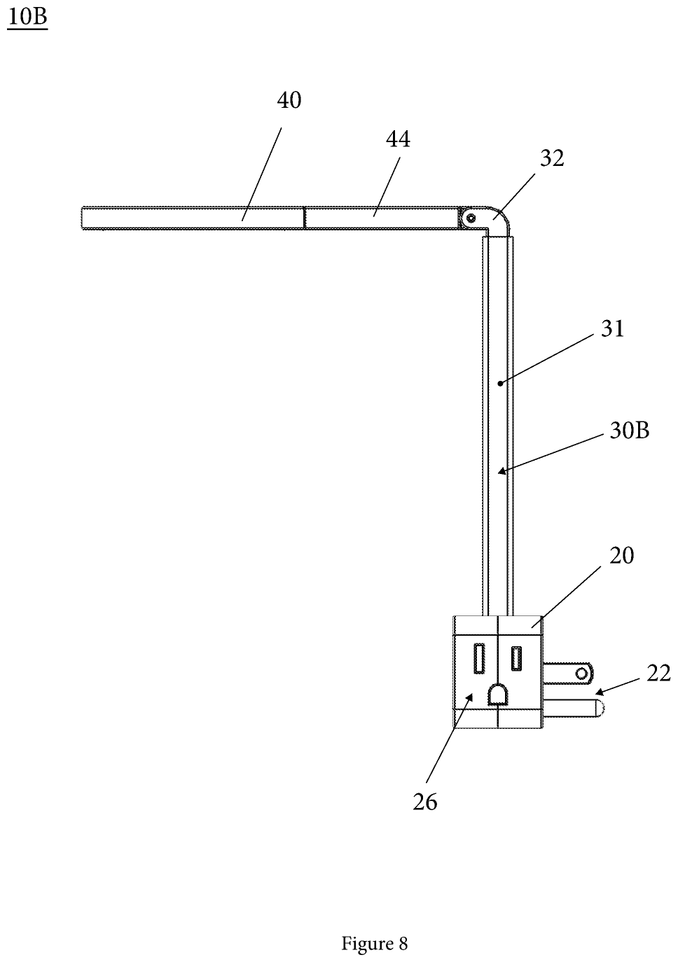

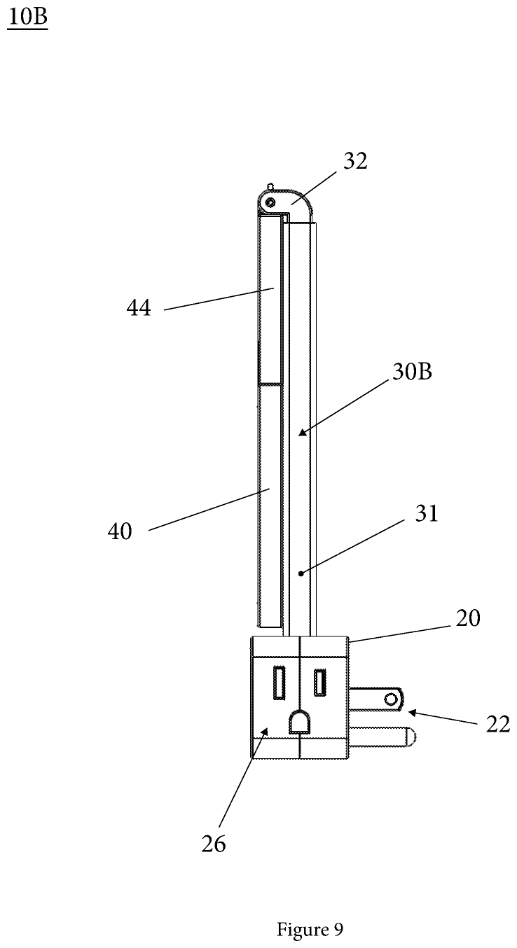

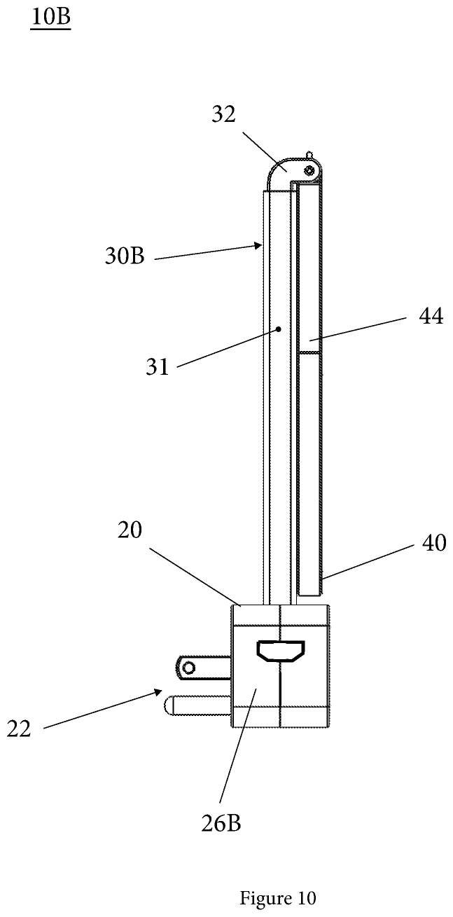

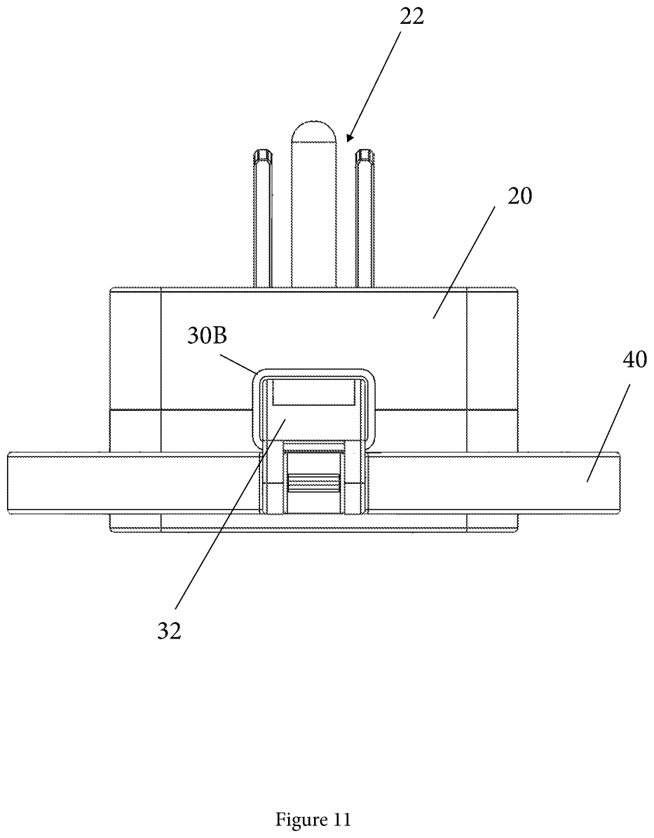

Referring to FIGS. 6-11, there is illustrated other views of lighting system or device 10B which highlight the portability and storage aspects of the invention. Device 10B includes an arm 30B with a body 31 that is optionally not extendable and where body 31 provide additional stability. Further, this embodiment illustrates a USB port 26B for charging electronic devices directly with a USB style cable connected to the electronic device. This embodiment is not limited to a USB port and can be other ports for charging such as Firewire or other ports that may evolve depending on the electronic device charging needs.

In one example embodiment, there is provided a undercabinet lighting device including a base housing including therein an electrical circuit for providing current to a light element and an actuating member for turning the current on and off. The device further includes an arm extending from the base housing and including a cantilevering portion at a distal end of the arm spaced away from the base housing. Further, a lamp head assembly is included that is coupled to a distal end of the cantilevering portion of the arm, the lamp head assembly including the light element. In one example the arm is of a telescoping configuration to provide extension capabilities.

In another example embodiment, there is provided a lighting assembly including a base housing including therein an electrical circuit for providing current to a light element and an arm extending from the base housing and including a cantilevering portion at a distal end of the arm spaced away from the base housing. The device also includes a lamp head assembly coupled to a distal end of the cantilevering portion of the arm, the lamp head assembly including the light element, with the cantilevering portion being configured to actuate the current on to the light element upon upward movement of the cantilevering portion.

In yet another example embodiment, there is provided a lighting and charging assembly including a base housing including therein an electrical circuit for providing current to a light element and an actuating member for turning the current on and off and an arm extending from the base housing and including a cantilevering portion at a distal end of the arm spaced away from the base housing. The assembly also includes a lamp head and inductive charging assembly coupled to a distal end of the cantilevering portion of the arm, the lamp head assembly including the light element on a bottom portion and an inductive charging pad on a top portion. In one example embodiment, the actuating member includes a four-way switch for four states: a light on only state; an inductive charging pad on only state; both light and inductive charging pad on state and an off state. In related embodiment, the electrical circuit is configured to actuate the light element in a momentary blink mode to indicate an electronic accessory placed on the inductive charging pad is completely charged.

The following patents are incorporated by reference in their entireties: U.S. Pat. Nos. 6,808,289; 8,403,515; 8,820,965; 8,872,435; 10,305,303; and 10,361,580.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

We claim:

1. An undercabinet lighting device comprising:
a base housing including therein an electrical circuit for providing current to a light element and an actuating member for turning the current on and off;
an arm extending from the base housing and including a cantilevering portion at a distal end of the arm spaced away from the base housing; and
a lamp head assembly coupled to a distal end of the cantilevering portion of the arm, the lamp head assembly including the light element.

2. The lighting device of claim 1 wherein the arm includes a body having therein an extension member extendible from the body in a telescoping configuration.

3. The lighting device of claim 1 wherein the base housing includes at least one set of prongs for AC power sourcing to provide current to the light element.

4. The lighting device of claim 1 wherein the lamp head assembly is configured to include at least one of a ring of LED lights or a light bar populated with LED lights.

5. The lighting device of claim 3 wherein the base housing includes at least one outlet thereon for providing AC power to an external device connected thereto.

6. The lighting device of claim 1 wherein the arm is further configured to cantilever away from the base housing at a proximal end of the arm.

7. The lighting device of claim 3 wherein the electrical circuit is configured to convert electrical power from an AC power source to DC electrical power when the lighting device is connected to the AC power source.

8. The lighting device of claim 2 having a compact configuration whereby the lamp head assembly collapses toward the arm and the extension member retracts into the arm body.

9. The lighting device of claim 1 wherein the base housing includes a battery source to provide current to the light element.

10. The lighting device of claim 1 wherein the base housing includes an electrical circuit to convert a 12 VDC source for providing current to the light element.

11. The lighting device of claim 1 wherein the base housing includes an electrical circuit to direct current generated from a solar cell positioned on the lighting device to the light element.

12. The lighting device of claim 4 wherein the lamp head assembly coupled to the cantilevered portion is configured to support an item located on a top surface opposite the light element, wherein the item is electrically connected to an AC power source via the base housing.

13. The lighting device of claim 12 wherein the item is selected from a group consisting of a smartphone, a flip-phone; a wrist device; and an electronic accessory.

14. The lighting device of claim 12 wherein the lamp head assembly includes an inductive charging pad on a top surface that is electrically connected to the AC power source.

15. A lighting assembly comprising;
a base housing including therein an electrical circuit for providing current to a light element;
an arm extending from the base housing and including a cantilevering portion at a distal end of the arm spaced away from the base housing; and
a lamp head assembly coupled to a distal end of the cantilevering portion of the arm, the lamp head assembly including the light element;
wherein the cantilevering portion is configured to actuate the current on to the light element upon upward movement of the cantilevering portion.

16. The lighting assembly of claim 12 wherein the arm includes a body having therein an extension member extendible from the body in a telescoping configuration.

17. The lighting assembly of claim 12 wherein the electrical circuit is configured to convert a power source to current for the light element, the power source selected from the group consisting of a battery, AC plug-in power; DC plug-in power, and a solar cell.

18. A lighting and charging assembly comprising:
a base housing including therein an electrical circuit for providing current to a light element and an actuating member for turning the current on and off;
an arm extending from the base housing and including a cantilevering portion at a distal end of the arm spaced away from the base housing; and
a lamp head and inductive charging assembly coupled to a distal end of the cantilevering portion of the arm, the lamp head assembly including the light element on a bottom portion and an inductive charging pad on a top portion.

19. The lighting and charging assembly of claim 18 wherein the actuating member is configured to be a four-way switch for four states: a light on only state; an inductive charging pad on only state; both light and inductive charging pad on state and an off state.

20. The lighting and charging assembly of claim 18 wherein the electrical circuit is configured to actuate the light element in a momentary blink mode to indicate an electronic accessory placed on the inductive charging pad is completely charged.
